(19) United States
(12) Patent Application Publication
(10) Pub. No.: US 2016/0063433 A1
(43) Pub. Date: Mar. 3, 2016

(54) SHIPMENT DATA LOGGER

(71) Applicants: Dane Glasgow, Los Altos, CA (US); Sergio Pinzon Gonzales, JR., San Jose, CA (US); Ilya Brown, Piedmont, CA (US)

(72) Inventors: Dane Glasgow, Los Altos, CA (US); Sergio Pinzon Gonzales, JR., San Jose, CA (US); Ilya Brown, Piedmont, CA (US)

(21) Appl. No.: 14/471,420

(22) Filed: Aug. 28, 2014

(51) Int. Cl. G06Q 10/08; G06Q 50/28

(52) U.S. Cl. CPC G06Q 10/0832; G06Q 50/28

(57) ABSTRACT

A system and method for a shipment data logger are described. The shipment data logger receives shipping condition parameters and instructions and generates generate shipping handling data based on sensors in the shipment data logger. The shipment data logger is configured to provide authorized access to the shipping handling data. The shipping handling data is analyzed relative to the shipping condition parameters to generate a delivery recommendation.

### TECHNICAL FIELD

This application relates generally to the field of computer technology and, in a specific example embodiment, to a method and system for a shipment data logging device.

### BACKGROUND

Online marketplaces allow sellers to list or publish information concerning items for sale. Once a buyer places an order for an item, the seller fulfills the order by shipping the item to the buyer. The item being shipped can include a fragile item. Other items can include temperature sensitive items that require special handling.

Once the item has been shipped, the condition of the handling of the shipped item becomes unknown to the seller and the buyer until delivery. Only then, the buyer may be able to determine the shipping handling conditions based on visible physical conditions, such as tears or dents on the package. Non-physical damages may not be determined until the buyer opens the package. For example, a temperature-sensitive item in a package may have been exposed to extreme heat in a delivery truck before being transferred to a shipping warehouse, resulting in damage to the item. As such, the buyer does not have the opportunity to refuse delivery of the package until the buyer accepts delivery, opens the package, and determines that the item has been damaged.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a shipment data logger application.

FIG. 4 shows a block diagram illustrating one example embodiment of an initialization module.

FIG. 5 shows a block diagram illustrating one example embodiment of an access module.

FIG. 6 shows a block diagram illustrating another example embodiment of a shipment data logging device.

FIG. 7 shows a flow diagram illustrating one example embodiment of an operation of the shipment data logger application.

FIG. 8 shows a flow diagram illustrating one example embodiment of an operation of the shipment data logging device.

FIG. 9 shows a flow diagram illustrating another example embodiment of an operation of the shipment data logging device.

FIG. 10 shows a ladder diagram illustrating one example embodiment of an operation of the shipment data logger application.

FIG. 11 shows a ladder diagram illustrating another example embodiment of an operation of the shipment data logger application.

FIG. 12 shows a diagrammatic representation of machine, in the example form of a computer system, within which a set of instructions may be executed to cause the machine to perform any one or more of the methodologies discussed herein.

FIG. 13 is a block diagram illustrating a mobile device, according to an example embodiment.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a shipment data logger are described. The shipment data logger receives shipping condition parameters and instructions and generates shipping handling data based on sensors in the shipment data logger. The shipment data logger is configured to provide authorized access to the shipping handling data. The shipping handling data is analyzed relative to the shipping condition parameters to generate a delivery recommendation.

In one example embodiment, a delivery recommendation is generated for a package that contains the shipment data logger based on the processed shipping handling data relative to the shipping condition parameters. The delivery recommendation may be, for example, a recommendation for a recipient of the package to accept a delivery of the package, or a recommendation for the recipient of the package to refuse the delivery of the package.

In another example embodiment, the recommendation to accept the delivery is generated in response to the shipping handling data satisfying the shipping condition parameters. The recommendation to reject the delivery is generated in response to the shipping handling data falling outside the shipping condition parameters. The shipping condition parameters identify acceptable shipping handling conditions for the item.

In another example embodiment, the shipment data logger communicates the delivery recommendation for the package to a mobile device of an addressed recipient of the package prior to the addressed recipient accepting delivery of the package. The shipment data logger can also communicate the delivery recommendation for the package to a shipping carrier server associated with the package prior to delivery of the package.

In another example embodiment, the shipment data logger wirelessly communicates the shipping handling data to a mobile device of an addressed recipient of the package prior to the addressed recipient accepting delivery of the package, and to a shipping carrier server associated with the package coupled to the shipment data logger.

The sensors may include an accelerometer, a humidity sensor, a temperature sensor, and a geolocation sensor.

In another example embodiment, the shipment data logger generates an alert in response to the shipping handling data exceeding to the shipping condition parameters and sends the alert to the shipping carrier server and the mobile device of the package recipient during shipment of the package in response to the shipping handling data exceeding the shipping condition parameters.

### System Architecture

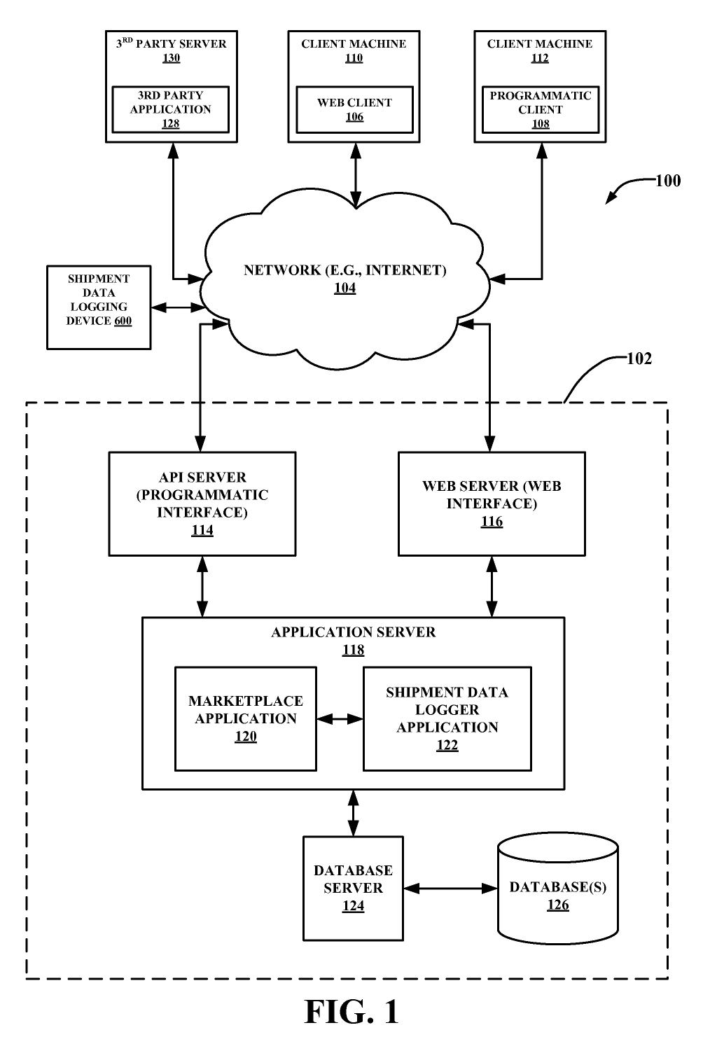

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a shipment data logger application 122, may provide server-side functionality via a network 104 (e.g., the Internet) to one or more clients. The one or more clients may include users that utilize the network system 100 and, more specifically, the marketplace application 120 and the shipment data logger application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the shipment data logger application 122, an application program interface (API) server 114 and a web server 116 are coupled to, and provide programmatic and web interfaces respectively to, one or more application servers 118. The application server 118 hosts one or more marketplace applications 120 and the shipment data logger application 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the shipment data logger application 122 includes a system and a method for setting shipping conditions data recording based on sensors disposed in a shipping box or package. The sensors may be part of a shipment data logging device 600 that may be dropped or part of a shipping package. For example, the shipment data logger application 122 may set shipping conditions based on the type or condition of item being shipped. Preset parameters for the shipping conditions may be defined based on the type of item being shipped. For example, a porcelain vase of height h1 and weight w1 may be considered extremely fragile. As such, the handling of the package containing the porcelain vase may not exceed a preset acceleration range such as acceleration range (g1, g2). In another example, the item being shipped may include an item sensitive to humidity. As such, a preset humidity parameter (humidity 1) may be defined for the particular item. Other types of shipping handling parameters may be defined such as, for example, temperature, electromagnetic field, orientation, acceleration, and vibration.

The shipment data logger or shipment data logging device 600 may record and log shipping handling data from sensors within the shipment data logger. The shipping handling data may be wirelessly communicated to a server or another computing device for analysis. For example, a shipping carrier server may receive the shipping handling data and analyze the performance of their package handling based on the shipping handling data. The performance may identify the time and frequency of the package being dropped or bumped or left in excessive heat or cold temperature.

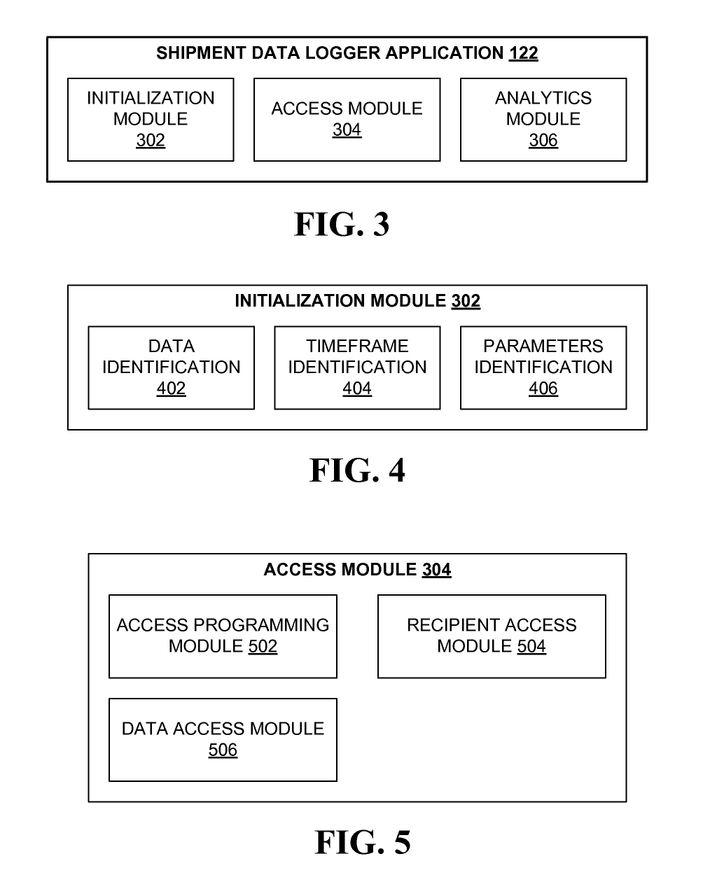

The shipment data logger may also generate a recommendation based on the shipping handling data and the preset or user defined shipping handling parameters for the item. For example, the shipment data logger may have detected that the package has been exposed to a temperature t1 greater than the preset shipping handling temperature parameter t2 for a period of time p1 exceeding a preset shipping handling period of time p2 for the item. In response, the shipment data logger may generate and communicate a recommendation to the recipient to refuse delivery of the item. Components of the shipment data logger application 122 are described in more detail below with respect to FIG. 3.

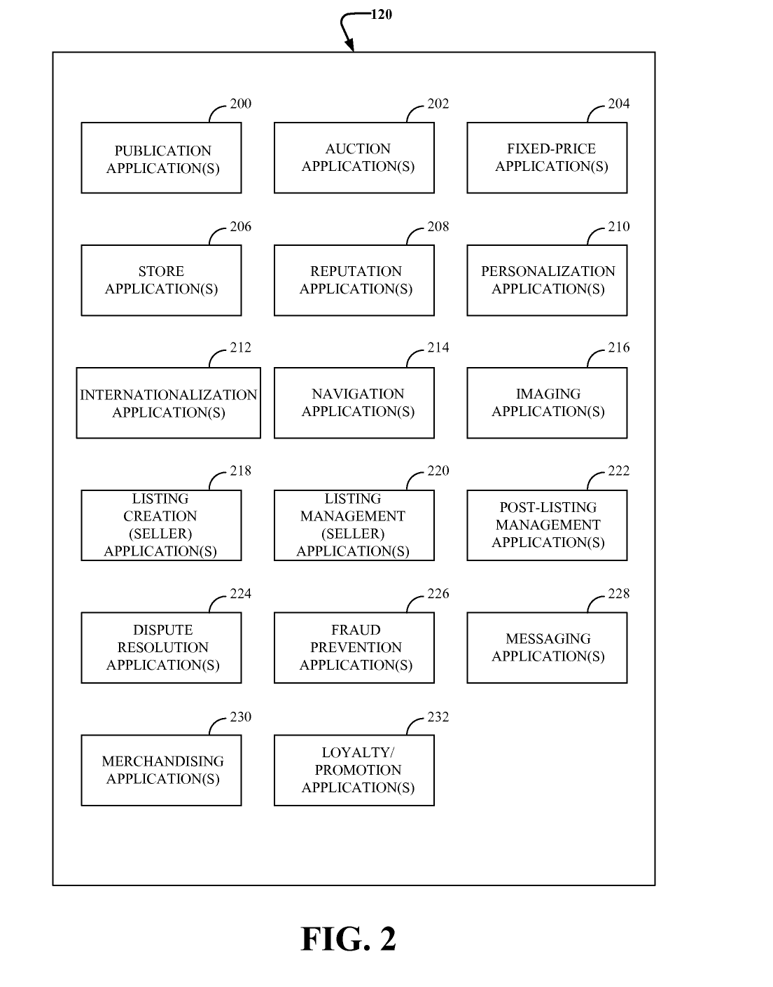

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the shipment data logger application 122 themselves are communicatively coupled (e.g., via appropriate interfaces) to each other and to various data sources, so as to allow information to be passed between the marketplace application 120 and the shipment data logger application 122 or so as to allow the marketplace application 120 and the shipment data logger application 122 to share and access common data. The marketplace application 120 and the shipment data logger application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable keyword searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

### Shipment Data Logger Application

FIG. 3 shows a block diagram illustrating one example embodiment of the shipment data logger application 122. The location-based delivery application 122 includes an initialization module 302, an access module 304, and an analytics module 306.

The initialization module 302 generates shipping condition parameters and instructions to generate shipping handling data based on the plurality of sensors. For example, a database store predefined parameters based on an identification or type of item to be shipped. A set of parameters may be associated with a particular type or category of item (e.g. perishable, fragile, extremely fragile, perishable group A, and so forth). The shipping condition parameters includes predefined limits applied to the data generated by the sensors. For example, a shipping condition parameter includes a temperature range t1 to t2 for a temperature sensor. The temperature range defines acceptable temperatures for an item being shipped. The temperature range may be based on the item, the type of item, a category of item, a brand of item, and so forth. Another example of shipping condition parameter includes predefined limits applied to data generated by shock sensors to determine whether the package has been dropped. For example, a shipping condition parameter includes an accelerometer range a1 to a2 for an accelerometer. The accelerometer range defines acceptable movements of the package. For example, a fragile vase may have a smaller accelerometer range than the accelerometer range of an electronic item. Other shipping condition parameters may include, for example, orientation and humidity levels. The shipping condition parameters may be based on the item being shipped.

The instructions to the initialization module 302 may include instruction as to when to activate the sensor, which sensor to activate, and how long the sensors are activated. For example, the initialization module 302 may generate instructions to activate the sensors in response to the package being scanned or received by a shipping carrier. A scanning device of the shipping carrier may communicate wirelessly with the initialization module 302 to activate the corresponding sensors. The initialization module 302 is described in more detail below with respect to FIG. 4.

The access module 304 configured to provide authorized access to the shipping handling data. For example, the access module 304 may be configured to enable communication between a shipment data logging device and an online marketplace, a shipping carrier device, a device of a sender, and a device of a recipient. The initializing device may be configured by the access module 304 to enable access to the shipping handling data for specific devices. For example, the shipping carrier device may have access to the entire shipping handling data generated by all the sensors in the package. The device of the recipient may have limited access to the shipping handling data. The access module 304 enables authorized access via authentication techniques (e.g., passcode, authentication credentials). For example, the access module 304 may generate a unique code directed to the device of the recipient. The unique code is communicated to the recipient such that the device of the recipient has access to the shipping handling data by “pairing” with the shipment data logging device using the unique code. The access module 304 is described in more detail below with respect to FIG. 5.

The analytics module 306 is configured to analyze the shipping handling data relative to the shipping condition parameters. In one embodiment, the analytics module 306 generates a delivery recommendation for a package having the shipment data logger inside based on the processed shipping handling data relative to the shipping condition parameters. For example, the delivery recommendation may include a recommendation to a recipient of the package to accept a delivery of the package, and a recommendation to the recipient of the package to refuse the delivery of the package. In another example, the delivery recommendation may include a recommendation for the shipping carrier not to proceed with the delivery of the package, to proceed with an insurance claim, or to return the package back to the sender.

The analytics module 306 generates the recommendation to accept the delivery in response to the shipping handling data satisfying the shipping condition parameters. For example, the temperature detected by the sensors in the package falls within acceptable temperate range t1 to t2 during the shipping. The analytics module 306 may generate the recommendation to reject the delivery in response to the shipping handling data falling outside the shipping condition parameters. For example, the humidity detected by the sensors in the package exceeds a low humidity level threshold or a high humidity level threshold. As previously described, the shipping condition parameters identify acceptable shipping handling conditions for the item. The analytics module 306 may aggregate data from sensors associate with a brand of item, a type of item, a shipping carrier, a shipping route. The aggregated data may be analyzed to determine patterns. For example, a particular shipping carrier may have the most package drops for an item compares to another shipping carrier for the same item and same route.

In another embodiment, the access module 304 sends the alert to the shipping carrier server and the mobile device of the package recipient during shipment of the package in response to the shipping handling data exceeding the shipping condition parameters.

In another embodiment, the analytics module 306 may compute statistics based on the aggregate sensor data from multiple shipment data logging devices. The analytics module 306 may identify patterns and trends based on shipping carrier, item, geographic location, and so forth. For example, the analytics module 306 may determine that packages experience more drops with one particular shipping carrier, route, or item than another. The analytics module 306 may be used to recommend a particular shipping carrier or shipping mode based on item specification. For example, the analytics module 306 may recommend using next-day delivery with shipping carrier A for a temperature sensitive item from Florida.

FIG. 4 shows a block diagram illustrating one example embodiment of the initialization module 302. The initialization module 302 includes a data identification module 402, a time frame identification module 404, and a parameters identification module 406. The data identification module 402 may be configured to identify the types of data to be collected by the sensors along with a detection frequency. For example, the type of data may include the temperature detected by a sensor every five minutes. The time frame identification module 404 may be configured to identify times when the sensors are turned on and off. For example, the time frame identification module 404 may indicate that the temperature is to be detected from the time the shipping carrier receives the package to the time when the package arrives at the recipient. The parameters identification module 406 may be configured to identify acceptable ranges for the data collected by the sensors. For example, the parameters identification module 406 may identify a range of acceptable temperatures for a particular item being shipped.

FIG. 5 shows a block diagram illustrating one example embodiment of the access module 304. The access module 304 includes an access programming module 502, a recipient access module 504, and a data access module 506. The access programming module 502 configures which device has access to the data generated by the sensors. The recipient access module 504 configures how the recipient has access to the data generated by the sensors. For example, the device of the recipient provides an authentication code to the shipment data logging device to access the data. The data access module 506 configures what type of data can be accessed by the devices of the shipping carrier, the sender, and the recipient. For example, the device of the recipient has only access to the recommendation generated by the analytics module 306. In another example, the device of the shipping carrier may have access to the entire shipping data (also referred to as sensor data) generated by the sensors.

### Shipment Data Logging Device

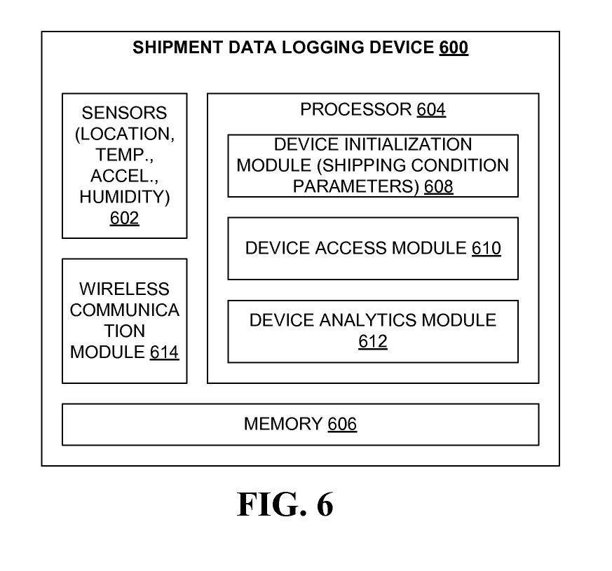

FIG. 6 shows a block diagram illustrating an example embodiment of a shipment data logging device 600. The shipment data logging device 600 may include sensors 602, a processor 604, a memory 606, and a wireless communication module 608. In one embodiment, the shipment data logging device 600 may be disposed or inserted in a package to be shipped. In another embodiment, the shipment data logging device 600 may comprise a non-reusable and disposable device.

The sensors 602 may include a geographic location sensor, a temperature sensor, an accelerometer, and a humidity sensor. Those of ordinary skills in the art will recognize that other types of sensors 602 may be included in the shipment data logging device 600. The processor 604 may include a hardware processor. The processor 604 may include a device initialization module 608, and device access module 610, and a device analytics module 612. The memory 606 may store the data from the sensors 602. In another embodiment, the shipment data logging device 600 may include a visual indicator to indicate a status of the package. For example, an LED may flash a red light if the data from the sensors has exceeded the thresholds. The recipient can therefore refuse delivery of the item upon noticing the flashing red light. In another embodiment, the visual indicator may be activated only upon arrival at the recipient's address based on the GPS of the shipment data logging device 600 or other geolocation sensing means.

The device initialization module 608 may be configured to receive instructions on when to use activate or deactivate the sensors 602 and the frequency of detection. The device initialization module 608 may also be configured to receive shipping condition parameters based on the item being shipped.

The device access module 610 may be configured to communicate the delivery recommendation for the package to a mobile device of an addressed recipient of the package prior to the addressed recipient accepting delivery of the package. In another example, the device access module 610 is configured to communicate the delivery recommendation for the package to a shipping carrier server associated with the package prior to delivery of the package.

The device analytics module 612 may process the shipping data from the sensors 602 locally to generate the delivery recommendation. In another embodiment, the device analytics module 612 may offload the processing of the data from the sensors 602 to an external processing device. For example, the device analytics module 612 may determine that the amount of data exceeds a predefined data size threshold, and request another device external to the shipment data logging device 600 to process the large amount of data.

The wireless communication module 614 may be configured to wirelessly communicate the shipping handling data to a mobile device of an addressed recipient of the package prior to the addressed recipient accepting delivery of the package. In another embodiment, the wireless communication module 608 may be configured to wirelessly communicate the shipping handling data to a shipping carrier server associated with a package coupled to the shipment data logger. The wireless communication module 608 may be implemented using for example, Wi-Fi, Bluetooth, radio signals, or any other wireless means.

The shipment data logging device 600 may be powered via a variety of power sources, including but not limited to solar power, battery power, kinetic power (e.g., movement of the package). In another embodiment, the analytics module 612 may determine that data values from one or more sensors have very little variation over a period of time, the device analytics module 612 may lower or adjust the frequency of the sensors. For example, several variation thresholds may be set (e.g., temperature variation of plus or minus 0.5 degrees C.) for each sensor. If the temperature stays within a variation threshold, the frequency of detection may be lowered so as to save battery power. Another higher variation thresholds may be set (e.g., + or −1 degree C.) to correspond with another sensing frequency.

In another embodiment, the shipment data logging device 600 may be used to monitor shipping conditions of packages, crates, items between warehouses of a retailer. For example, the retailer may use the shipment data logging device 600 to determine the condition of the shipping of the items while in transit. The retailer may thus determine that a crate of items is likely defective based on the data from the shipment data logging device 600 without having to open the crate to visual inspect the items (e.g., temperature sensitive food has spoiled because a truck's climate control malfunction). In another example, shipment of items between retail stores may also be monitored using the shipment data logging device 600.

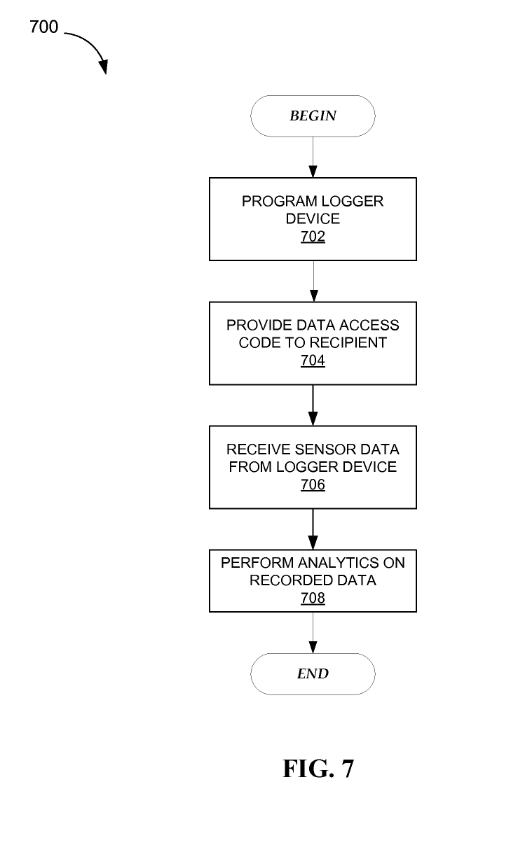

FIG. 7 shows a flow diagram illustrating one example embodiment of a method for the shipment data logger application 122. At operation 702, a shipment data logging device 600 may be initialized and programmed to instruct the shipment data logging device 600 on what to detect and when to detect. At operation 704, the shipment data logging device 600 may be provided with a unique data access code corresponding to the recipient of the package. The shipment data logging device 600 communicates the recipient the unique data access code via another communication channel such as email or text messaging. As such, the recipient is able to access the shipping data from the shipment data logging device 600 by providing the unique data access code to the shipment data logging device 600.

In another embodiment, the shipment data logging device 600 may be provided with another unique data access authentication token corresponding to a third party so that the third-party can access the shipping data from the shipment data logging device 600.

At operation 706, the shipment data logging device 600 receives data from its sensors 602. The data may be generated by the sensors 602 at a predefined frequency (e.g., every minute). At operation 708, the shipment data logging device 600 performs analytics on the recorded data. For example, the shipment data logging device 600 may determine whether some of the shipping data exceeds acceptable thresholds. In another embodiment, the shipment data logging device 600 does not perform any analytics but instead wirelessly offloads the shipping data to another device for further computation.

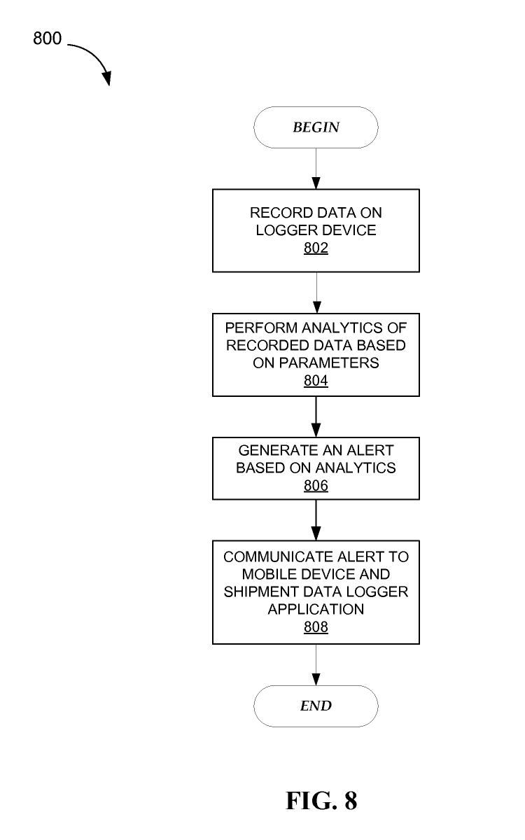

FIG. 8 shows a flow diagram illustrating one example embodiment of a method 800 for the shipment data logging device 600. At operation 802, the shipment data logging device 600 records data from its sensors 602. The data may be generated by the sensors 602 at a predefined frequency (e.g., every minute). At operation 804, the shipment data logging device 600 performs analytics on the recorded data based on predefined parameters related to an item being shipped. For example, the shipment data logging device 600 may determine whether some of the sensor data exceeds acceptable thresholds. At operation 806, the shipment data logging device 600 generates an alert based on the performed analytics. For example, the shipment data logging device 600 may identify the time period and geographic location where the package has been subjected to extreme humidity. At operation 808, the shipment data logging device 600 may generate and communicate an alert to a mobile device of the recipient or to the shipment data logger application 122. In one embodiment, the shipment data logging device 600 may attempt to wirelessly communicate with other wireless device using accessible or public Wi-Fi network, low energy Bluetooth, or other wireless means. For example, the shipment data logging device 600 may communicate when a Wi-Fi antenna of the shipment data logging device 600 is within range of a Wi-Fi network of the shipping carrier. Trucks and warehouses of the shipping carrier may be equipped with Wi-Fi routers. The shipment data logging device 600 may be preconfigured to be authenticated only with the Wi-Fi routers of the shipping carrier. In another embodiment, the shipment data logging device 600 may communicate over a cellular network, or other wireless communication networks.

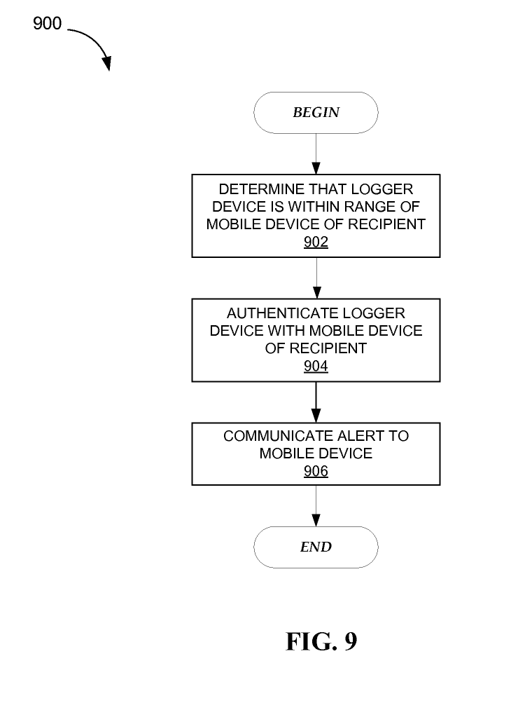

FIG. 9 shows a flow diagram illustrating another example embodiment of a method 900 for the shipment data logging device 600. At operation 902, the shipment data logging device 600 determines whenever it is within a wireless range of the mobile device of the recipient. For example, the shipment data logging device 600 determines whenever it has Bluetooth access to the mobile device of the recipient. At operation 904, once the shipment data logging device 600 is within communication range of the mobile device of the recipient, the shipment data logging device 600 attempts to communicate and authenticate with the mobile device of the recipient. For example, the mobile device of the recipient may pair with the shipment data logging device 600 using a previously provided authentication code. At operation 906, once the shipment data logging device 600 is in communication with the mobile device of the recipient, the shipment data logging device 600 can communicate the delivery recommendation or an alert to the mobile device of the recipient.

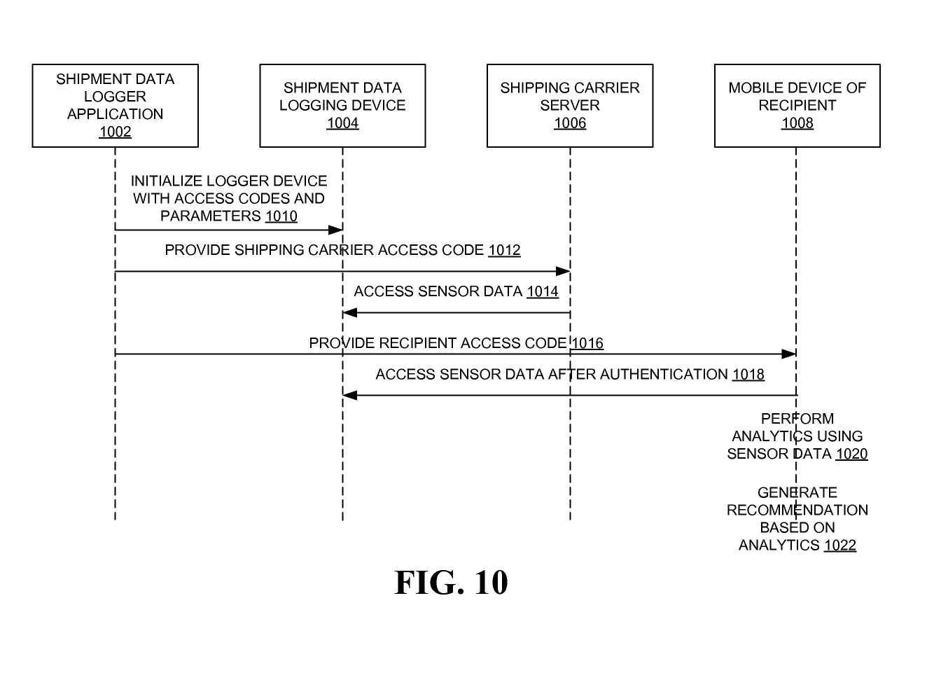

FIG. 10 shows a ladder diagram illustrating one example embodiment of an operation of the shipment data logger application 122. At operation 1010, a shipment data logger application 1002 initializes a shipment data logging device 1004 with access codes and shipment parameters. At operation 1012, the shipment data logger application 1002 provides a shipping carrier access code to a shipping carrier server 1006. The shipping carrier server 1006 can then authenticate with the shipment data logging device 1004 and access shipment data from the shipment data logging device 1004 at operation 1014. At operation 1016, the shipment data logger application 1002 provides a recipient access code to a mobile device of a recipient of the package 1008. The mobile device of the recipient 1008 can then access sensor data from the shipment data logging device 1004 at operation 1018 using the previously provided recipient access code. In another embodiment, the mobile device of the recipient 1008 authenticates with the shipment data logging device 1004 via other means of authentication. At operation 1020, the mobile device of the recipient 1008 can perform analytics using the shipment data from the shipment data logging device 1004. At operation 1022, the mobile device of the recipient 1008 generates a recommendation based on the analytics.

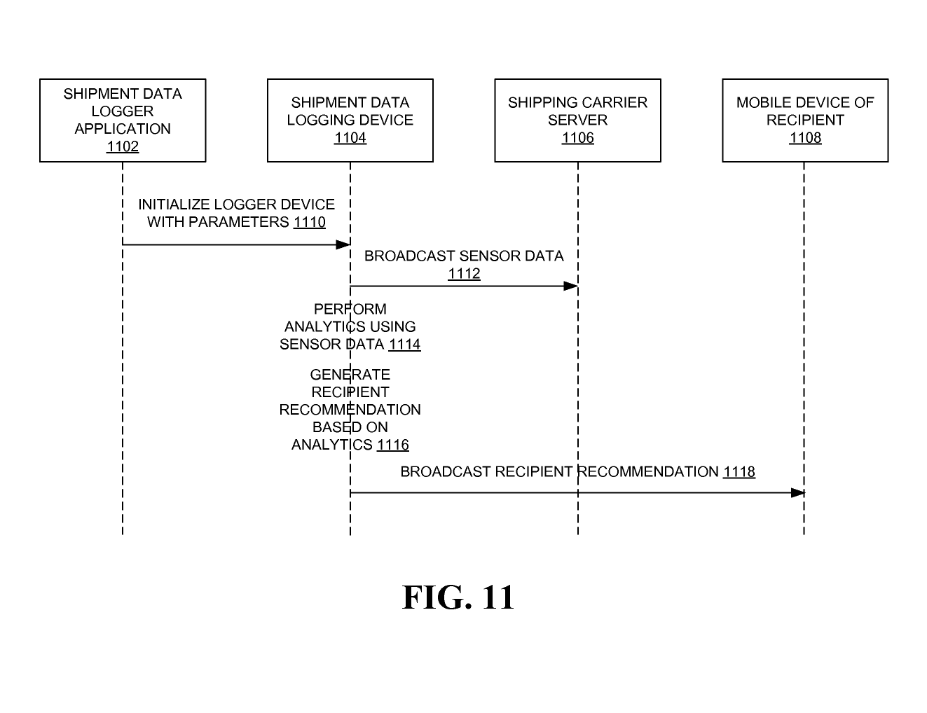

FIG. 11 shows a ladder diagram illustrating another example embodiment of an operation of the shipment data logger application 1102. At operation 1110, a shipment data logger application 1102 initializes a shipment data logging device 1104 with acceptable shipment parameters. At operation 1112, the shipment data logging device 1104 wirelessly broadcast sensor data. For example, the shipment data logging device 1104 may broadcast using a specific channel. A shipping carrier server 1106 receives the broadcasted sensor data as the shipment data logging device 1104 travels through warehouses and shipping trucks. In one embodiment, the warehouses and shipping trucks may be equipped with wireless devices that are configured to receive the broadcast sensor data from the shipment data logging device 1104. At operation 1114, the shipment data logging device 1104 performs analytics using the sensor data and generates a recipient recommendation based on the analytics at operation 1116. At operation 1118, the shipment data logging device 1104 broadcasts the recipient recommendation to a mobile device of the recipient 1108 when the shipment data logging device 1104 is within wireless communication range of the mobile device of the recipient 1108. The recipient recommendation may be a recommendation for the recipient to accept or refuse delivery of the package from the shipping carrier.

### Modules, Components And Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus And System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 104.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network 104. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### EXAMPLE COMPUTER SYSTEM

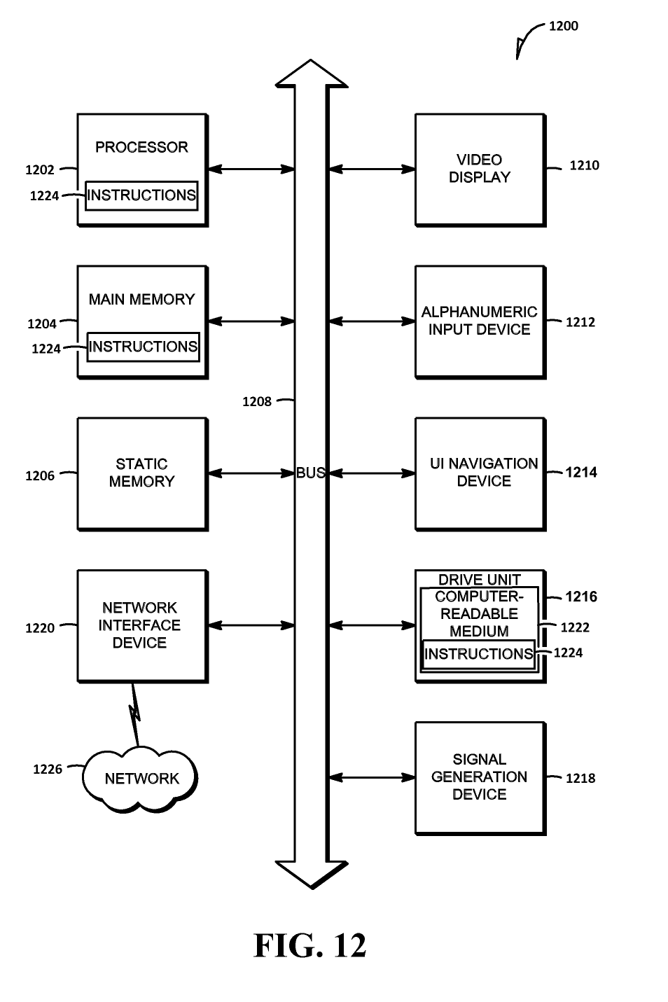

FIG. 12 shows a diagrammatic representation of a machine in the example form of a computer system 1200 within which a set of instructions 1224 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1224 (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein.

The example computer system 1200 includes a processor 1202 (e.g., a central processing unit (CPU), a graphics processing unit (GPU), or both)), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a UI navigation device 1214 (e.g., a mouse), a disk drive unit 1216, a signal generation device 1218 (e.g., a speaker), and a network interface device 1220.

The disk drive unit 1216 includes a computer-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

The instructions 1224 may further be transmitted or received over a network 1226 via the network interface device 1220 utilizing any one of a number of well-known transfer protocols (e.g., HTTP).

While the computer-readable medium 1222 is shown in an example embodiment to be a single medium, the term “computer-readable medium” should be taken to include a single medium or multiple media (e.g., a centralized or distributed database 126, and/or associated caches and servers) that store the one or more sets of instructions 1224. The term “computer-readable medium” shall also be taken to include any medium that is capable of storing, encoding, or carrying a set of instructions 1224 for execution by the machine and that cause the machine to perform any one or more of the methodologies of the present disclosure, or that is capable of storing, encoding or carrying data structures utilized by or associated with such a set of instructions 1224. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

### EXAMPLE MOBILE DEVICE

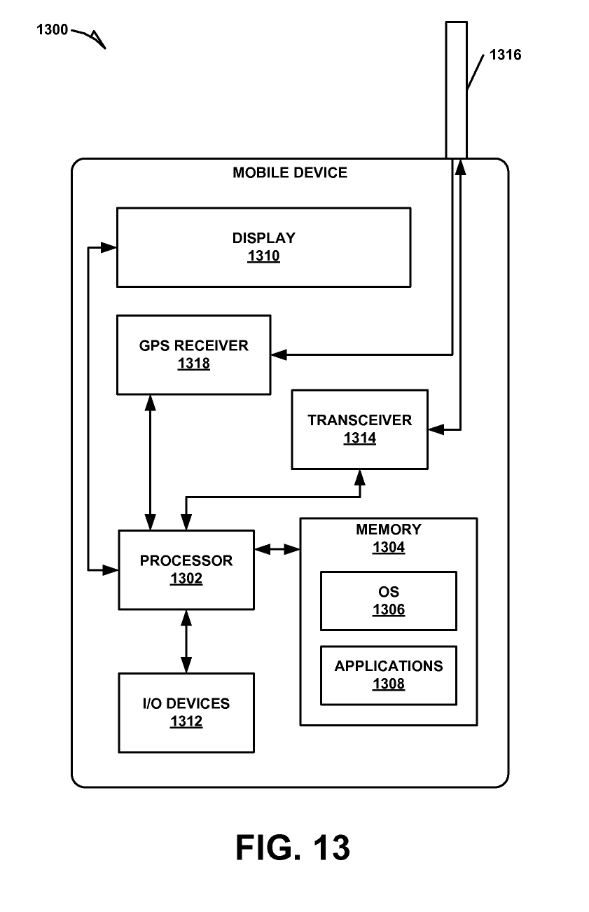

FIG. 13 is a block diagram illustrating a mobile device 1300, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or other type of memory, is typically accessible to the processor 1302. The memory 1304 may be adapted to store an operating system (OS) 1306, as well as application programs 1308, such as a mobile location enabled application that may provide location-based services (LBSs) to a user. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A shipment data logger comprising:
a plurality of sensors;
an initialization module, executable by a hardware processor, configured to receive shipping condition parameters and instructions to generate shipping handling data based on the plurality of sensors;
an access module configured to provide authorized access to the shipping handling data; and
an analytics module configured to analyze the shipping handling data relative to the shipping condition parameters and generate a delivery recommendation.

2. The system of claim 1, wherein the analytics module is configured to generate the delivery recommendation prior to delivery of a package containing the shipment data logger to a recipient of the package.

3. The system of claim 2, wherein the delivery recommendation comprises a selection from the group consisting of: a recommendation for a recipient of the package to accept a delivery of the package, and a recommendation for the recipient of the package to refuse the delivery of the package.

4. The system of claim 3, wherein the analytics module generates the recommendation to accept the delivery in response to the shipping handling data satisfying the shipping condition parameters, and the recommendation to reject the delivery in response to the shipping handling data falling outside the shipping condition parameters,
wherein the shipping condition parameters identify acceptable shipping handling conditions for the item.

5. The system of claim 2, wherein the access module is configured to communicate the delivery recommendation for the package to a mobile device of an addressed recipient of the package prior to the addressed recipient accepting delivery of the package.

6. The system of claim 2, wherein the access module is configured to communicate the delivery recommendation for the package to a shipping carrier server associated with the package prior to delivery of the package.

7. The system of claim 1, further comprising:
a wireless communication module configured to wirelessly communicate the shipping handling data to a mobile device of an addressed recipient of the package prior to the addressed recipient accepting delivery of the package.

8. The system of claim 1, further comprising:
a wireless communication module configured to wirelessly communicate the shipping handling data to a shipping carrier server associated with a package coupled to the shipment data logger.

9. The system of claim 1, wherein the plurality of sensors comprises a selection from the group consisting of: an accelerometer, a humidity sensor, a temperature sensor, and a geolocation sensor.

10. The system of claim 1, wherein the analytics module is configured to generate an alert in response to the shipping handling data exceeding to the shipping condition parameters,
wherein the access module is configured to send the alert to the shipping carrier server and the mobile device of the package recipient during shipment of the package in response to the shipping handling data exceeding to the shipping condition parameters.

11. A method comprising:
receiving shipping condition parameters and instructions to generate shipping handling data based on a plurality of sensors of a shipment data logger;
configuring authorized access to the shipping handling data;
analyzing, using a hardware processor of the shipment data logger, the shipping handling data relative to the shipping condition parameters; and
generating a delivery recommendation based on the analysis of the shipping handling data relative to the shipping condition parameters.

12. The method of claim 11, further comprising:
generating the delivery recommendation prior to delivery of a package containing the shipment data logger to a recipient of the package.

13. The method of claim 12, wherein the delivery recommendation comprises a selection from the group consisting of: a recommendation for a recipient of the package to accept a delivery of the package, and a recommendation for the recipient of the package to refuse the delivery of the package.

14. The method of claim 13, further comprising:
generating the recommendation to accept the delivery in response to the shipping handling data satisfying the shipping condition parameters; and
generating the recommendation to reject the delivery in response to the shipping handling data falling outside the shipping condition parameters,
wherein the shipping condition parameters identify acceptable shipping handling conditions for the item.

15. The method of claim 12, further comprising:
communicating the delivery recommendation for the package to a mobile device of an addressed recipient of the package prior to the addressed recipient accepting delivery of the package.

16. The method of claim 12, further comprising:
communicating the delivery recommendation for the package to a shipping carrier server associated with the package prior to delivery of the package.

17. The method of claim 11, further comprising:
wirelessly communicating the shipping handling data to a mobile device of an addressed recipient of the package prior to the addressed recipient accepting delivery of the package, and to a shipping carrier server associated with the package coupled to the shipment data logger.

18. The method of claim 11, wherein the plurality of sensors comprises a selection from the group consisting of: an accelerometer, a humidity sensor, a temperature sensor, and a geolocation sensor.

19. The method of claim 11, further comprising:
generating an alert in response to the shipping handling data exceeding to the shipping condition parameters;
sending the alert to the shipping carrier server and the mobile device of the package recipient during shipment of the package in response to the shipping handling data exceeding to the shipping condition parameters.

20. A non-transitory computer-readable storage medium storing a set of instructions that, when executed by a processor, cause the processor to perform operations, comprising:
receiving shipping condition parameters and instructions to generate shipping handling data based on a plurality of sensors of a shipment data logger;
configuring authorized access to the shipping handling data; and
analyzing the shipping handling data relative to the shipping condition parameters; and
generating a delivery recommendation based on the analysis of the shipping handling data relative to the shipping condition parameters.
